(19) United States
(12) Patent Application Publication
(10) Pub. No.: US 2002/0059481 A1
(43) Pub. Date: May 16, 2002

(54) METHOD AND APPARATUS FOR A MULTIMEDIA APPLICATION SPECIFIC PROCESSOR

(76) Inventor: PATRICK O. NUNALLY, DEL MAR, CA (US)

Correspondence Address: BLAKELY SOKOLOFF TAYLOR & ZAFMAN, 12400 WILSHIRE BOULEVARD SEVINTH FLOOR, LOS ANGELES, CA, 90025

(21) Appl. No.: 09/223,679

(22) Filed: Dec. 30, 1998

(51) Int. Cl. G06F 3/00; G06F 15/00; G06F 15/76

(52) U.S. Cl. 710/5; 710/20; 712/36; 712/15; 712/37

(57) ABSTRACT

The present invention is a method and apparatus for performing a multimedia function. A data port receives the input data. A shared memory is coupled to the data port for storing the input data. A multimedia syntax is coupled to the shared memory for processing the input data based on a configuration information. The multimedia syntax corresponds to the multimedia function.

### BACKGROUND

1. Field of the Invention

This invention relates to application specific processors. In particular, the invention relates to multimedia application specific processors.

2. Description of Related Art

With the proliferation of advanced computer and communication technologies, multimedia applications have become increasingly popular. In particular, there is a high demand for highly integrated multimedia systems which involve all media forms including video, audio, data, and graphics. In addition, many of the multimedia applications use communication technologies to transfer media data over communication networks (e.g., internet) such as video conference, interactive television, video phone, etc.

One communication technology area that multimedia have not been fully exploited is mobile communication technology. Products using mobile communication technologies include hand-held devices (e.g., e-mail, Web browser), cellular telephone handsets, transportable devices, information organizers, personal digital assistants (PDA), Mobile communication systems such as wireless products have their particular requirements. Examples of these requirements include low cost, high reliability, flexibility, light weight, hand-held capability, ease of use, small size, low power consumption, and mobility, etc. To meet most of these requirements, it is preferable to use single-chip devices or processors with highly integrated functionalities. However, multimedia applications usually involve highly complex designs and architectures. Therefore, providing multimedia functionalities in single-chip devices for mobile communication systems is a design challenge.

In general, two approaches have been developed for designing single-chip processors: “standard cell” and “gate array” technologies. One of the problems with both these approaches is that it is difficult to use them to design ICs which perform complicated functions. This is because the standard cells and gate arrays are primitive or simple logic blocks for all types of applications. Consequently, it takes a lot of time, skill, and effort to integrate these basic building blocks into useful application specific integrated circuits for multimedia applications. In addition, the layout and timing constraints and the design effort required to interconnect these logic blocks normally limit the designer's freedom and increase the design time.

To overcome these difficulties, an approach that uses pre-designed reconfigurable elements for communication applications has been suggested. U.S. Pat. No. 5,623,684 issued to H. S. El-Ghoroury, Dale A. McNeill, and Charles A. Krause describes the architecture and design method for an application specific processor (ASP) with particular applications in communication. However, the techniques described in this patent do not specifically have applications in multimedia.

Therefore there is a need in the technology to provide a flexible and versatile processor for multimedia and communication applications.

### SUMMARY

The present invention is a method and apparatus for performing a multimedia function. A data port receives the input data. A shared memory is coupled to the data port for storing the input data. A multimedia syntax is coupled to the shared memory for processing the input data based on a configuration information. The multimedia syntax corresponds to the multimedia function.

### BRIEF DESCRIPTION OF THE DRAWINGS

The features and advantages of the present invention will become apparent from the following detailed description of the present invention in which:

FIG. 1 is a diagram illustrating a system in which a preferred embodiment of the invention can be practiced.

FIG. 2 is a diagram illustrating a media application specific processor (MASP) according to a preferred embodiment of the invention.

FIG. 3 is a diagram illustrating in detail an interface access circuit shown in FIG. 2 according to a preferred embodiment of the invention.

FIG. 4 is a diagram illustrating in detail a clock enable circuit shown in FIG. 2 according to a preferred embodiment of the invention.

FIG. 5 is a diagram illustrating in detail a media syntax circuit shown in FIG. 2 according to a preferred embodiment of the invention.

FIG. 6 is a diagram illustrating a process for designing a MASP according to a preferred embodiment of the invention.

FIG. 7 is a diagram illustrating a functional architecture of a media application specific processor (MASP) according to a preferred embodiment of the invention.

FIG. 8 is a diagram illustrating a video motion encoder and decoder shown in FIG. 7 according to a preferred embodiment of the invention.

### DESCRIPTION

In the following description, for purposes of explanation, numerous details are set forth in order to provide a thorough understanding of the present invention. However, it will be apparent to one skilled in the art that these specific details are not required in order to practice the present invention. In other instances, well-known electrical structures and circuits are shown in block diagram form in order not to obscure the present invention.

The present invention is a method and apparatus for processing multimedia data using a media application specific processor (MASP) . The MASP includes a data port to receive multimedia input data, a shared memory to store input data, and a multimedia syntax to process the input data based on a configuration information. The multimedia syntax corresponds to a multimedia function. The technique provides flexible and versatile multimedia processing elements in a single semiconductor device.

The present invention is a multimedia processor architecture and design method in which a plurality of functional elements, each designed to performed a specific multimedia function, are connected together to cooperatively perform a multimedia task. The architectural context in which these functional elements are integrated and the combination of the functional elements in order to perform the multimedia processing is referred herein as a multimedia application specific processor (MASP).

In a preferred embodiment, the MASP comprises a number of elements, which collectively form a programmable processor architecture for execution of instructions in a multimedia system. The MASP uses a plurality of physical application elements interconnected on a command/data/timing bus to cooperatively perform a plurality of processing functions useful in a multimedia system.

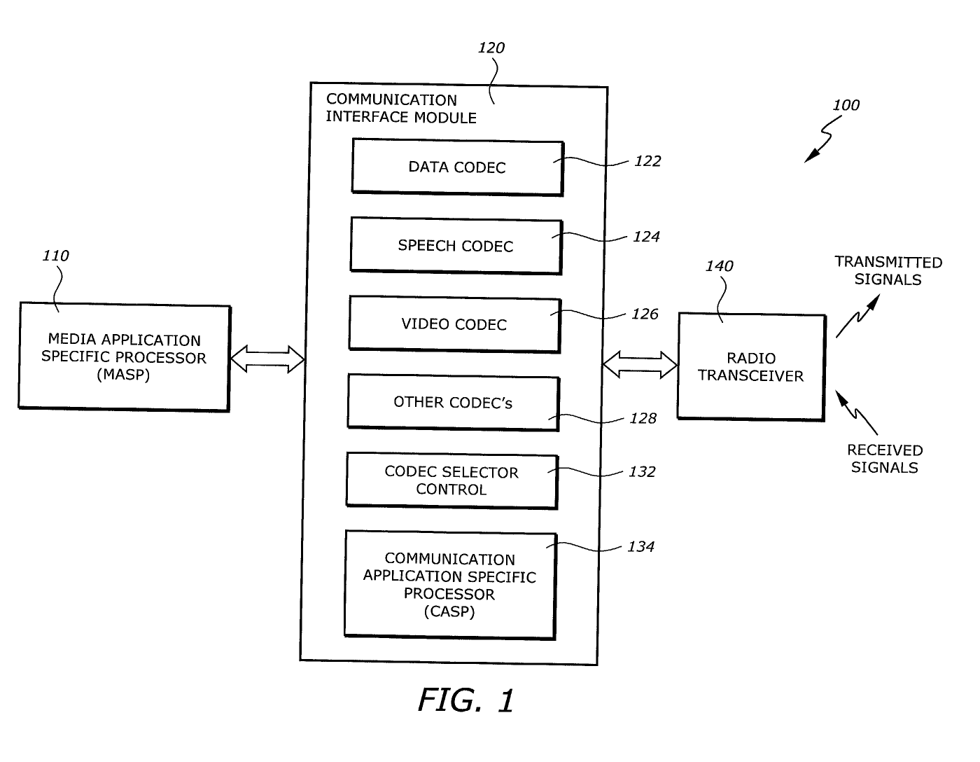

FIG. 1 is a diagram illustrating a system in which a preferred embodiment of the invention can be practiced. The system 100 includes a multimedia application specific processor (MASP) 110, a communication interface module (CIM) 120, and a radio transceiver 140.

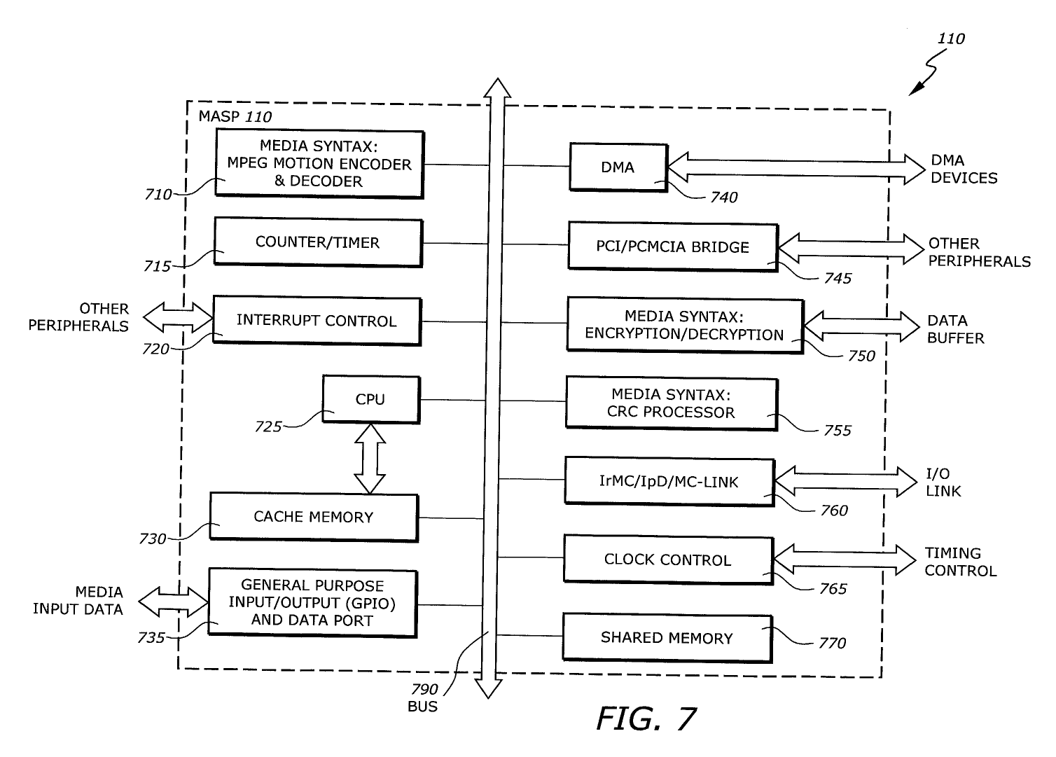

The MASP 110 is a single-chip semiconductor device that is designed to perform a number of multimedia and communication functions in a suitable communication environment such as wireless mobile station systems in the GSM. Examples of multimedia and communication functions include video compression and decompression, audio compression and decompression, data transport, baseband radio transmission, baseband interfaces and filtering, source coding, source interfaces and filtering, control and supervision, power management, input/ output (I/O) drivers, memory management and code compaction, and other interfaces. The MASP 110 includes a data port (shown in FIG. 7 as item 735) to interface to the communication interface module 120 to receive and transmit data. These circuits perform interface, protocol conversion and data rate adaption between a data source such as a PC, PDA, FAX, data terminal, positioning and/or navigation system, electronic map ant/or guidance system, telemetry and control equipment, wireline modem for POTS or ISDN and other wireless equipment. The data port interface is any commonly used serial or parallel data interface such as RS-232, IEEE 802.3 or PCMCIA. All of these are hosted via the command/timing/data bus as shown.

The CIM 120 provides input/output interface to the MASP 110. The CIM 120 includes a data codec 122, a voice codec 124, a video codec 126, other codecs 128, a codec selector control 132, and a communication application specific processor (CASP) 134. The data codec 122 provides coding and decoding interface of data terminal equipment such as personal computer (PC), personal digital assistant (PDA), fax, etc. The voice codec 124 provides coding and decoding interface to audio data such as data from telephone signal. The video codec 126 provides coding and encoding interface to video data from video or image sources such as video cameras. Other codecs 128 provide coding and decoding interface to other multimedia information. The codec selector control 132 controls the selection of the appropriate codecs for the media function performed by the MASP 110. The CASP 134 performs a number of communication functions on the baseband signals received from or transmitted to the radio transceiver 140. Examples of these functions include up- and down-conversion of the baseband to IF and RF, and provides for control of frequency and power and PA and LNA for the front-end.

The data source codec 122 converts the protocol and data rate to conform to the specified GSM channel formats. Common serial synchronous and asynchronous data formats and others, such as the Hayes AT command set and group 2 and 3 Fax can be implemented as well as any other specified protocol required to interpret to from the mobile system. More complex data formats such as ISDN and ATM are also supported. In other embodiments of the invention, ETSI terminal adapters are provided according to several standards such as GSM 0S:03-Channel coding, GSM 07.01-General on terminal adaptation functions for MSs, GSM 07.02-Terminal adaptation functions for services using asynchronous bearer capabilities, ant GSM 07.03 Terminal adaptation functions for services using synchronous bearer capabilities.

The radio transceiver 140 perform analog signal processing tasks including modulation and demodulation to convert the signal frequencies between baseband and radio frequency (RF). The radio transceiver 140 transmits and receives RF signals in a suitable communication platform, including wireless and mobile communication systems.

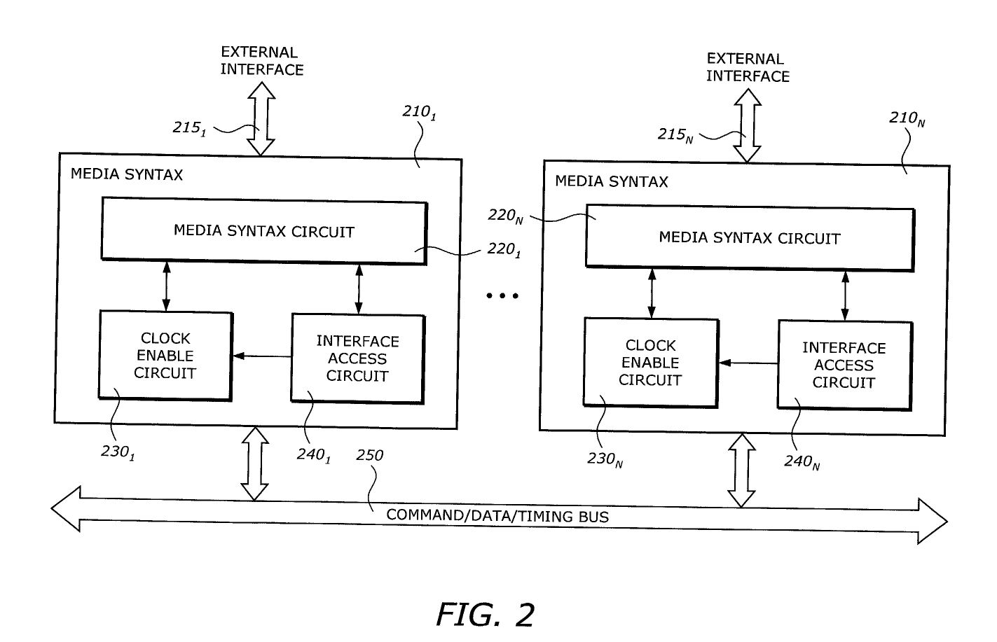

FIG. 2 is a diagram illustrating a media application specific processor (MASP) 110 as shown in FIG. 1 according to a preferred embodiment of the invention. The MASP includes a command/data/timing (CDT) bus 250 and N media syntax 215₁ to 215_{N} where N is any positive integer. These media syntax could be different, or some of them could be the same. Communication between the media syntax are carried out through the CDT bus 250. The CDT bus 250 carries the configuration data for the media syntax 210₁ to 210_{N}.

Each of the media syntax 210₁ to 210_{N} contains essentially the same circuits for interfacing with the CDT bus 250. Thus, it is sufficient to describe in detail the interface circuits of a representative media syntax, such as the media syntax 210₁. Media syntax 210₁ contains a clock enable circuit 230₁, an interface access circuit 240₁, and a media syntax circuit 220₁. The media syntax circuit 220₁ performs a predefined function. For example, FIG. 2 indicates that the media syntax circuit 220₁ operates on user data that is supplied to the media syntax 210₁ through a bidirectional path designated the external interface 215₁ line. The clock enable circuit 230₁ and interface access circuit 240₁ interface the media syntax circuit 220₁ to the CDT bus 250. The clock enable circuit 230 provides the media syntax circuit 220 only at the time when its function is needed. The interface access circuit 240 allows media syntax circuit 220 to receive commands and data from, and send commands and data to, other media syntax via the CDT bus 250.

In the MASP architecture 110, the structures of the clock enable circuit 230 and interface access circuit 240 in each media syntax 210₁ are substantially the same, although some unique components, such as the media syntax's address, are different. Some of the components in the media syntax circuit 220 are also common to all the media syntax 210₁ to 210_{N} (e.g., components interfacing with the clock enable circuit 230 and interface access circuit 240). However, circuits in the media syntax 210₁ which perform specific media functions may be different (e.g., one media syntax functions as a image compressor, another functions as a encryptor, etc.). Briefly stated, the media syntax 210₁ may perform different functions, but the portions of the media syntax 210₁ to 210_{N} for interfacing to the CDT bus 250 are substantially the same. As a result, the media syntax 210₁ to 210_{N} can interface to one another using the CDT bus 250.

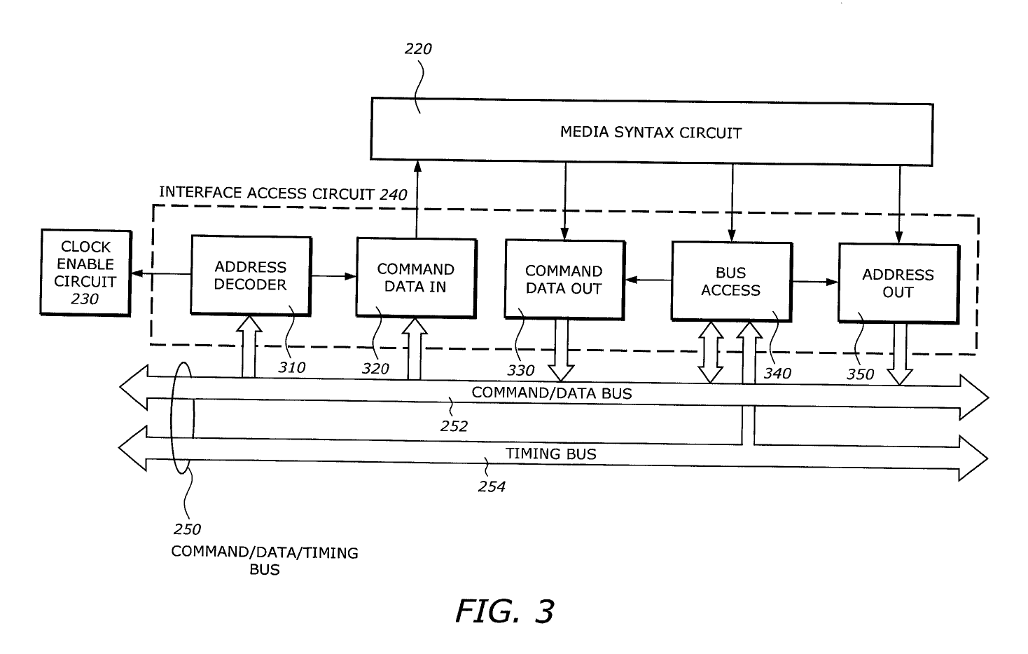

FIG. 3 is a diagram illustrating in detail an interface access circuit shown in FIG. 2 according to a preferred embodiment of the invention. The interface access circuit 240 includes an address decoder 310, a command/data in circuit 320, a command data-out circuit 330, a bus access circuit 340, and an address out circuit 350. The CDT bus 250 includes a command/data bus 252 and a timing bus 254. The address decoder 310 receives address signals from the command/data bus 252 and causes the command/data in circuit 320 and the clock enable circuit 230 to accept commands and data which are intended for media syntax 210₁ as shown in FIG. 2. The command and data processed by the command/data in circuit 320 is sent to the media syntax circuit 220. The command/data out circuit 330 and the address out circuit 350 transmit the command, data, and address information generated by the media syntax circuit 220 to the command/data bus 150. The bus access circuit 340 is connected to the command/data out circuit 330 and the address out circuit 350 to provide interface for accessing the CDT bus 250.

The command/data in circuit 320 and the command/data out circuit 330 operate on an input/output format which consists of a pair of command and data, each of varying size. The aggregate size of the command and data are based on the operational needs of the specific media syntax circuit. The described command and data pairing has moving boundaries which allows maximization of the physical interface (i.e., CDT bus 250) efficiency.

Because the structure of the interface access circuit 240 is substantially the same for all the media syntax 210₁ to 210_{N}, it is possible for one media syntax to send commands and data to another media syntax through the CDT bus 250. This “data driven” distributed control approach allows efficient implementation of highly time ordered, multi-mode application specific processing. Thus, in this architecture, there is no need for the control approach to be restricted to a fully centrally controlled approach; rather a distributed control, centralized control, or a hybrid control approach can be used to best match the needs of the intended application. The ability of a media syntax to generate commands to other media syntax allows one media syntax to become a central controller for a group of other media syntax, which are designated as an media syntax cluster.

Another advantage of this architecture is that the CDT bus 250 is hidden from the media syntax circuit (i.e., the media syntax circuit need not know the details of the bus operation). Thus, the designer of the specific function for a media syntax does not have to know the bus operation and as a result, there is a gain in economy.

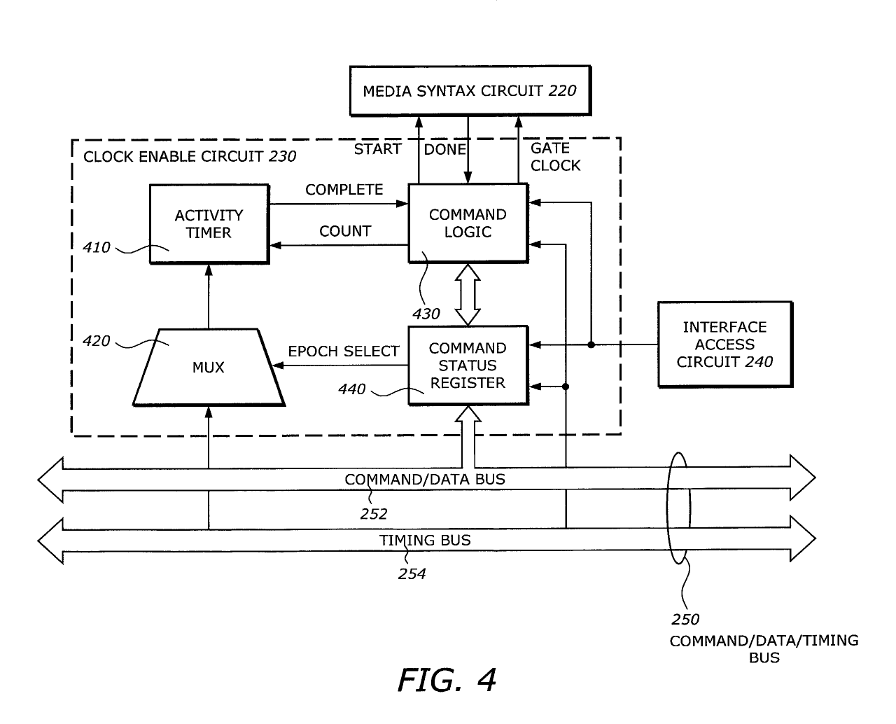

FIG. 4 is a diagram illustrating in detail a clock enable circuit shown in FIG. 2 according to a preferred embodiment of the invention. The clock enable circuit 230 includes an activity timer 410, a multiplexer (MUX) 420, a command logic 430, and a command status register 440.

The command status register 440 receives time-related commands and data which are addressed to the media syntax 2101. The command status register 440 uses these commands and data to determine a mux select value and a epoch modulo value. The mux select value is sent to the multiplexer 420 through a set of epoch select lines so that the multiplexer 420 can select the desired clock (or epoch) from the timing bus 254. The epoch modulo value is sent to the command logic circuit 430 and defines the modulo therein (i.e. number of epochs to count before enabling a gated-clock), as explained below.

The output of the multiplexer 420 is connected to the activity timer 410. The activity timer 410 also receives a “count” signal from the command logic circuit 430. This count signal corresponds to the epoch modulo value, described above, in the command logic circuit 430. The activity timer 420 uses this count signal to count the epochs (selected by the command status register 440) and sends a “complete” signal to the command logic circuit 430. The command logic circuit 430 then enables a gated-clock and generates a start signal (synchronous to the gated-clock). The start signal and gated-clock are coupled to the media syntax circuit 220. The command logic circuit 430 receives a “done” signal from the media syntax circuit 220. The command logic circuit 430 also contains circuits which allow it to enable and disable the gated-clock via commands from the command status register 440.

The clock enable circuit 230 causes the media syntax circuit 220 to be activated at specific occurrences of the specified timing epoch. For example, the clock enable circuit 230 can be configured to activate the media syntax circuit 220 at predefined epochs and disable the gated-clock during idle times, thereby limiting power dissipation of the media syntax 210₁. Furthermore, the clock enable circuit 230 allows the autonomous operation of the media syntax 2101 based on timing epochs distributed through the system. Thus, by allowing each media syntax to be enabled only at the time when its function is needed to be invoked, both the time ordering of data processing and efficient power management become inherent aspects of the architecture.

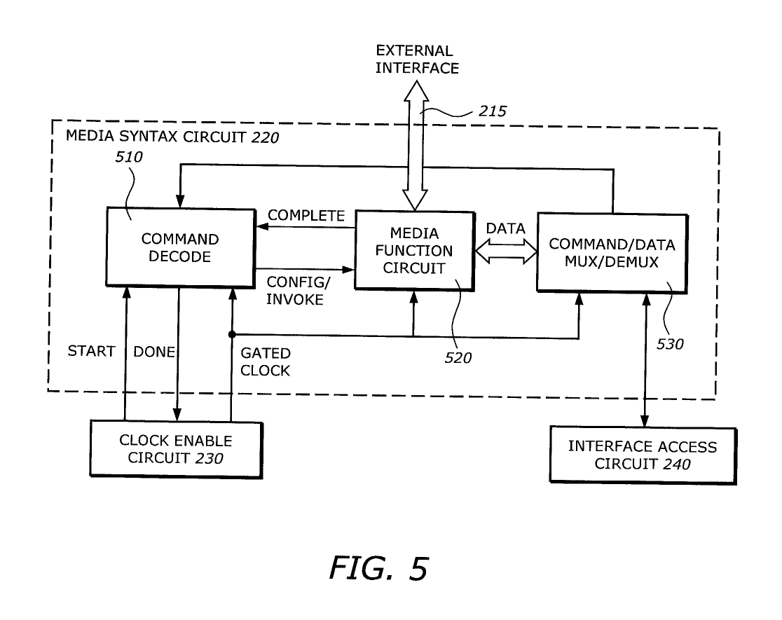

FIG. 5 is a diagram illustrating in detail a media syntax circuit shown in FIG. 2 according to a preferred embodiment of the invention. The media syntax circuit 220 includes a command decode 510, a media function circuit 520, and a command data multiplexer/demultiplexer (mux/demux) 530.

The media function circuit 520 performs predefined functions unique to a media syntax, such as transformation of the user data supplied via the external interface 215 line. That is, the media function circuit 520 contains circuits which are not part of the interface structure common to all media syntax. The command/data mux/demux circuit 530 receives commands and data from the interface access circuit 240 and the gated-clock signal from the clock enable circuit 230. The command/data mux/demux circuit 530 extracts commands (for delivery to the command decode 510) and data (for bi-directional communication to the media function circuit 520) received from the interface access circuit 240.

The command/decode 510 can be considered the controller of the media syntax circuit 220. It controls the operation of the media function circuit 520. The command/decode circuit 510 accepts commands from the interface access circuit 240 via the command/data mux/demux circuit 530, interprets those commands, and controls the operation of the media function circuit 520. An example of the operations are (i) configuring the media function circuit 520, and (ii) invoking a particular predefined transformation of the user data supplied by the external interface 215 line. Upon completion of a command, the media function circuit 520 sends a “complete” signal to the command/decode circuit 510.

The “start” signal received by the command/decode circuit 510 is used to synchronize the invocation of the media function circuit 520. The command/decode circuit 510 also generates a “done” signal and transmits it to the clock enable circuit 230, which is turn disables the gated-clock to the command/decode circuit 510, the media function circuit 520, and the command/data mux/demux circuit 530. Disabling the gated-clock to these circuits essentially turns them off. Conversely, enabling the gated-clock turns them on.

The media function circuit 520 in the media syntax circuit 220 is specifically designed to perform a predefined function. Each media syntax 210₁ to 210_{N} defines an application specific function which is a priori designed, implemented, and optimized for a target technology (for example, a specific microelectronics integration technology). A set of media syntax which perform different data and signal transformation functions can be put into a library. When it is time to design a system for a certain application (e.g., a modem for wireless communication, video and audio compression/ decompressions), appropriate media syntax are selected from the library and placed on the CDT bus 250 so that they can perform the desired function.

In the embodiment presented in FIGS. 2-5, the command arguments are transmitted on command/data bus 252 and processed by the interface access circuit 240 and the clock enabled circuit 230. The time arguments are transmitted on the timing bus 254 and processed mainly by the clock enable circuit 230.

The MASP architecture allows a set of media syntax to be invoked simultaneously (parallel processing), staggered in time (pipeline processing), or sequential in time (non-overlapping processing). This capability allows considerable flexibility in the system design choices. Invocations simultaneous in time (parallel processing) allow high processing throughput to be realized. Invocations staggered in time (pipeline processing) or sequential in time (non-overlapping processing) allow one media syntax to act as a preprocessor for another media syntax. The time (T) argument of each media syntax determines the alignment of invocation epochs to realize the most efficient processing relative to another media syntax.

Appropriate media syntax are selected from the library containing the complete set of available media syntax. The architectural design allows any set of media syntax to be interconnected in a fully connected topology, which permits data flow between any two media syntax. This interconnection is based on a loose coupling, whereby a set of media syntax can operate asynchronously.

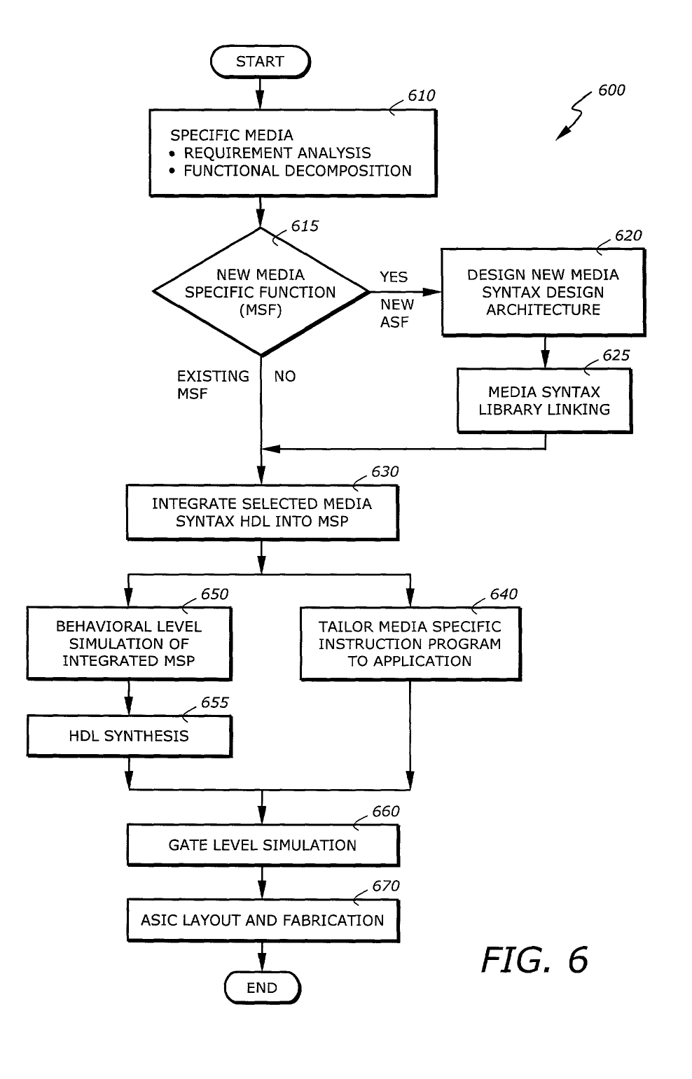

FIG. 6 is a diagram illustrating a process 600 for designing a MASP according to a preferred embodiment of the invention. Upon START, the processing requirements of the target product are analyzed and decomposed into fundamental media specific processes (Block 610), such as video compression/decompression, encryption/decryption. Next, the library of media specific function circuits is searched in order to identify the subset of media syntax suitable for meeting the identified processing needs (Block 615). If a new or unique media specific processing function is identified not to be contained in the library, these new or unique media processing needs are implemented using hardware description language (HDL) into an media syntax which incorporate the aforementioned interface to the MASP multi-purpose bus (Block 620). Then the process 600 proceeds to create or link to the media syntax library (Block 625). The newly designed media syntax HDL together with the HDL of those pre-designed media syntax identified to exist in the library are integrated to form an HDL of the target MASP integrated circuit (Block 630).

Behavioral level simulation is performed in order to ascertain whether the internal and external interfaces are compliant with the design specifications (Block 650). Concurrent with the behavioral level simulation, a media specific instruction program is designed, such that it can be used to sequence the operation of the selected media syntax in order to implement the processing requirement of the target media specific MASIC (Block 640). Next, the integrated HDL is synthesized with the appropriate computer-aided design (CAD) synthesis tool targeting the technology selected for implementation of the ASP (Block 655). Next, the resultant logic is combined with the media specific instruction program designed in Block 640 and simulated at the gate level in order to verify compliance with the target media specific requirements (Block 660). Upon completion of adequate gate level logic simulation, the design is released for ASIC layout and fabrication (Block 670), and the process 600 is terminated.

The media syntax library may be considered a collection of instructions in a programming language. A user can select the appropriate subset of instructions from the library to implement a programmable MASP which is matched to the intended application. The instruction set can be tailored to match the specific processing needs of a target application (for example, video communications). The MASP Architecture is an architecture in which instructions in the instruction set can be combined to work in a cooperative manner to perform a certain application. The individual members of this media specific instruction set are designed in a manner which captures a highly complex, yet frequently used, type of data transformation into a single “syntax” which can be addressed as a primitive instruction at the application level. This type of syntax is referred to as an “media syntax” or “application element” as discussed above.

Within the MASP architecture, an media syntax is invoked with two sets of fundamental arguments, namely, command (C) and time (T), forming a configuration data. In terminology analogous to software programming, the structure of the syntax is “Syntax (C,T).” Each syntax, when invoked, transforms a designated input array, data structure, and/or commands into an output by applying a media specific transformation or mapping. The command (C) argument of a syntax allows specific control parameters embedded with the media syntax to be set at desired values and hence allows the transformation performed by an media syntax to be varied from one invocation to another without altering the type of functional transformation performed. For example, within a MASP, a media syntax can be defined to be a filter function with the command argument allowing the filter bandwidth to be varied. The time (T) argument of the syntax allows the media syntax to be invoked at specific time epochs, where the value of the argument (T) specifies the time at which the media syntax is to be invoked or the time interval between successive invocations. When implemented in hardware, each syntax, when invoked, transforms a designated input array, data structure, and/or commands into an output by applying a media specific transformation or mapping. The command (C) argument of a syntax allows specific control parameters embedded within the media syntax to be set at desired values and hence allows the transformation performed by an media syntax to be varied from one invocation to another without altering the type of functional transformation performed.

Under the principles of the current invention, MASPs may be programmed both at the pre-synthesis and post-synthesis stages of their design. The overall design process, covering the requirements analysis, functional decomposition, media syntax library search, media syntax integration, etc., was described in detail in the context of FIG. 6 above. Pre-synthesis programmability refers particularly to the programmability provisions which allow the integrated circuit designer to further customize the design of each function circuit through adaptation of the HDL model of the function circuit. A summary of exemplary features that are either pre- or post-synthesis programmable are presented in Table 1 in the context of an MPEG-4 motion encoder. One skilled in the art could readily appreciate that some features could be implemented to be either pre-synthesis or post-synthesis programmable, while other features would preferably be implemented at one stage, but not the other (e.g. in a modem, use of binary phase shift keying versus quaternary preferably invoked pre-synthesis, while modem baud rate programmed in post-synthesis). The implementation of pre-synthesis programmability could be as simple as arranging the HDL model in a highly modular and commented fashion in order that unwanted functionality could be commented out and custom functionality added; or, in a more elaborate fashion, precompiler flags or macros could be used to control the invocation of particular functionality through the setting of particular parameters.

TABLE 1
Media Syntax Programmability

| | | | |
|---|---|---|---|
| Layer | Functionality | Pre-Synthesis | Post-Synthesis |
| | | | Programmability |
| | | Programmability | |
| Application | Application | Sample Bus Input | Coding types |
| Layer | Function Logic | Definition | |
| | (VHDL with | | |
| | standard | | Sampling Rate |
| | interfaces | | |
| Control Layer | Command/ | Epoch Definition | Invocation |
| | Decode Logic | | command |
| | | | Input Data |
| | | | Address |
| | Command/Data | | |
| | Mux/Demux | | Output Data |
| | | | Address |
| | Clock Enable | | |
| | Logic | | |
| Interface Layer | Command/ | Arbitration Logic | |
| | Data/Timing | Function Block | |
| | Bus | ID | |
| | Arbitration Logic | Input Addresses | |
| | Function Block | | |
| | ID | | |
| | Input Addresses | | |

In the current embodiment of the media specific processor architecture, the attributes of the multi-purpose bus, such as the bus width or clocking speed, can be pre-synthesis programmed to match the needs of the specific application. This allows the integrated circuit designer to optimize the multi-purpose bus, hence allowing efficient gate count implementation.

Inherent within the design of each of the function circuits, values of certain parameters of the processing algorithms are implemented using registers which can be programmed with any desired values. The size of these registers, and consequently the range of the programmable values of each register, can be pre-synthesis programmed to match the needs of the specific application. This also allows the designer to optimize the gate count to the needs of the specific application.

On the post-synthesis side, the application specific processor architecture of the present invention also permits programmability of the data transfer between any two function circuits. Thus, each function circuit can be programmed with the memory address of the input and output data as an integral part of commanding each function circuit.

As discussed above, values of certain parameters of the processing algorithms are implemented using registers which can be programmed with any desired values. Hence, each of the function blocks or circuits can be viewed as a parametrically programmable media specific high-order operation or instruction. This allows the media specific processor to be post-synthesis programmed to adjust the processing a capability of each function block to the instantaneous needs of the specific application.

Furthermore, each function block or circuit can be post-synthesis programmed to control its invocation time relative to a timing signal supplied to the function circuit on the multi-purpose bus.

Also inherent within the design of each media specific function circuit is the ability to gate the clock signal off between successive invocations. In effect, therefore, the media specific processor architecture actually allows programmability of the clock signal to each function block or circuit in terms of both the on/off period as well as the invocation epoch.

As a consequence of the moving boundary attribute of the multi-purpose bus, this bus can be viewed as being post-synthesis programmable to adapt the throughput needed to transfer data and commands between the interconnected function blocks or circuits. Since each function block or circuit in the media specific processor could have different data and command structure size, the invocation of the function blocks or circuits in accordance with a sequence of programmed instructions is in effect programming the multi-purpose bus in real-time to accommodate the data and command needs of the integrated function circuits.

Thus, as example of the post-synthesis programmability in the current embodiment, a “FILTER” instruction could be configured to process data thus:

FILTER(IN=@ received_signal_sample_bus, OUT=@ filtered_signal_bus, TYPE=FIR, NCOEF=Num_Coef, COeF=MF_Coef, TIME=Burst_CLK)

The first two arguments of the FILTER instruction sets up the connectivity of the filter. The first argument connects the filter input to the received signal bus, and the second argument connects the filter output to the filtered signal bus. The filter function will receive its input data from the received signal bus and write the resultant output data to the filtered signal bus. The next three arguments instructs the FILTER function circuit to execute a Finite Impulse Response (FIR) type filter with the filter coefficients Num_Coef. The Num_Coef is a project specific constant, or equate, which is setup in the project database. The project database may specify such equate as data stored in a specific address in constant ROM (Read-only memory) or user configurable in RAM (Random Access Memory). The last argument of the FILTER instruction commands the filter function circuit to invoke on the epoch of the burst clock provided by the Command/Data/Timing bus.

Parameters not explicitly defined in the instruction declaration are set to default values. Default parameters for each media syntax may include internal bus widths, operating rates, architecture configurations, and miscellaneous configuration/control options. For example, the FILTER instruction can be fully configured using the default values with no explicitly defined parameters. In this option the FILTER instruction in the program would be FILTER().

In one embodiment, the instructions would be compiled and stored in a shared memory syntax, as described below, which may comprise RAM memory, with the program downloaded to the MASP at power-up. In an alternative embodiment, the shared memory syntax would comprise ROM instead or even complementing RAM, the ROM for storing the program and RAM for user-accessible and modifiable registers. In yet another embodiment, instructions or configuration parameters dependent on only one functional circuit could be stored in the respective circuit.

The MASP architecture of the present invention targets implementations incorporating microelectronics integrated circuit technologies as well as board level technologies. Because the constituent processing and invocation mechanisms are matched to a specific media application, the MASP architecture offers the maximum throughput which can be achieved by the target technology with sufficient programming flexibility to realize the low cost benefits achieved by aggregating the production volume of several product markets with common processing needs. For example, it is possible to build a library in which the digital video needs for the combined markets of several products, including teleconferencing, high definition television (TV), interactive TV, cellular telephones, wireless local area networks, personal communication networks, digital cable networks, etc., are accommodated. The architecture also enables leveraging the expertise of application experts to realize lower product design cost and short time-to-market advantages and allows system level object oriented programmability, which obviates the need for in-depth understanding of the complex aspects of a specific application processing. The rapid development cycle of efficient application specific circuits with inherent power management capabilities and the programming flexibility for addressing product enhancement and evolution with vastly reduced development cost are major benefits of this architecture.

One application of the MASP architecture of the present invention is a MPEG-4 video motion encoder. Table 2 shows the names and description of some of the media syntax in a library which can be used to design various MPEG-4 encoders.

TABLE 2
MPEG-4 Media Syntax Library

| Name | Description |
|---|---|
| Coding Control | Determine timing and flag (interframe/intraframe, |
| | transmit/not transmit flags), quantization |
| | scale, type of coding |
| Data switching | Switch data from video input or from motion |
| | estimation and compensation. |
| DCT | Perform discrete cosine transform. |
| Quantizer | Quantize transformed data and generate |
| | quantization index. |
| Inverse Quantize | Perform inverse quantization |
| IDCT | Perform inverse discrete cosine transform. |
| Motion estimation | Estimate motion vectors and generate |
| and compensation | compensated video frames. |
| Wavelet coding | Perform sub-band coding on an image. |
| Fractal coding | Perform fractal coding (e.g., intraframes) |
| Region-Object-based | Perform scene analysis, region labeling, |
| coding | region representation. |
| Model-based coding | Perform 3-D coding. |

The MASP has a number of media functions. These include video compression/decompression using JPEG/MPEG means, audio compression/decompression using MPEG, Dolby AC3 and vocoder methods, Graphics acceleration using matrix processing means, display control using polygon tracing means, encryption processing using Public Key, SET and DES methods. The processing segments interconnected by the command/timing/data bus perform all functionality required for transmitting and receiving source data in form of voice, data/FAX and still or moving images to and from the wireless mobile station user. This data may be in analog or digital format. An appropriate mixed signal conversion function is used to adapt to an analog source and convert the signal to the digital domain. The device then compresses and/or adapts the data rate of the source data flow and connects to the wireless Channel Coder according to the specifications for application channel desired.

FIG. 7 is a diagram illustrating a functional architecture of a media application specific processor (MASP) according to a preferred embodiment of the invention. FIG. 7 includes an MPEG motion encoder and decoder 710, a counter/ timer 715, an interrupt control circuit 720, a central processing unit (CPU) 725, a cache memory 730, a general purpose input/output (GPIO) and data port 735, a direct memory access (DMA) controller 740, a PCI/PCMCIA bridge 745, an encryption/decryption processor 750, a cyclic redundancy check (CRC) processor 755, an infrared mobile communication/infrared data/mobile communication (IrMC/IrD/MC) link, a clock control circuit 765, a shared memory 770, and a bus 790. Although most of these elements are implemented by digital techniques, in some embodiments, some blocks or circuits may be implemented using analog or mixed signal cells as part of the their functionality. This facilitates maximum utilization of the CMOS single chip and minimizes use of external components.

The MPEG motion encoder and decoder 710 performs video motion encoding and decoding functions. The counter/timer 715 provides timing information for counting frames, lines, etc. The interrupt control 720 provides interface to interrupt other processors and peripherals, or to allow other peripherals to interrupt the MASP. Examples of the interrupt control includes interrupt priority, interrupt vectoring, etc. The CPU 725 may be any suitable processor such as the Acorn RISC machine (ARM), or other advanced embedded processors. The cache memory 730 provides a private cache memory for the CPU 725 to allow fast access of stored data items. The GPIO data port 735 provides interface to input/output devices, including the media input data. The data sources may be a video data stream captured from a video camera, an audio data stream from a voice input signal.

The DMA controller 740 provides direct memory access to DMA devices for fast and efficient data transfer. The DMA 740 may have interface to data buffers which may store video or audio data digitized by a video digitizer and/or an audio digitizer. The PCI/PCMCIA bridge 745 provides interface to the PCI bus or the PCMCIA ports. The encryption/decryption processor 750 encrypts and decrypts data for transmission and reception in a secure platform. The CRC processor 755 provides error checking to the data processing. The IrMC/IrD/MC-link 760 provides interface to I/O link in mobile communication environment. The clock control 765 provides control of clock signals to other circuits in the system. The page memory 770 is used to store page information. In a preferred embodiment, the page memory 770 is a memory that is shared by many processors or other media syntax.

In a typical application, the data port 735 received the media input data from the media source. Examples of the media input data include digital video channel, digital audio channel, or data channel. The received input data are then stored in the shared memory 770. The shared memory 770 is accessible to other media syntax or processors such as the I/DCT processor 710, the DMA controller 740, the CPU 725, the CRC processor 755, and the encryption/decryption processor 750. Thereafter, an appropriate media function is performed on the input data stored in the shared memory 770. This media function may be a video motion estimator, video motion compensator, audio compression/decompression, CRC processing, encrypting/decrypting, etc. These media functions are coordinated in a distributed manner to improve throughput.

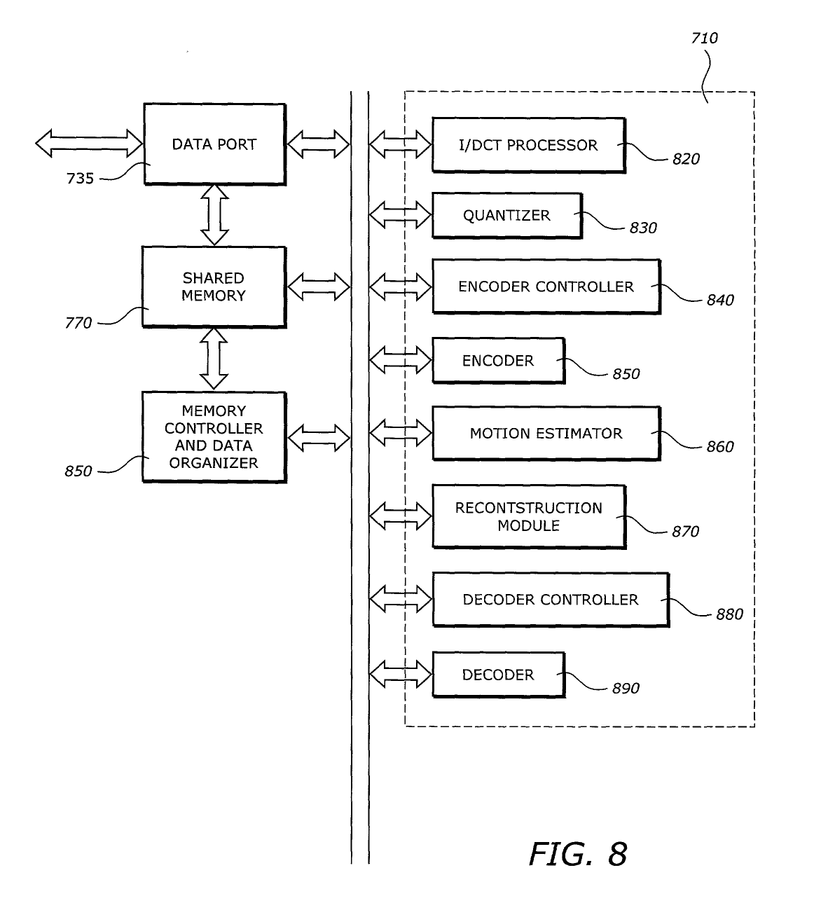

FIG. 8 is a diagram illustrating a video motion encoder and decoder 710 shown in FIG. 7 according to a preferred embodiment of the invention. The video motion encoder and decoder 710 includes an I/DCT processor syntax 820, a quantizer syntax 830, an encoder controller syntax 840, and encoder syntax 850, a motion estimator syntax 860, a reconstruction module syntax 870, a decoder controller 880, and a decoder syntax 890. FIG. 8 also illustrates the data port 735, the shared memory 770, and a memory controller and data organizer 850.

The I/DCT processor syntax 820 performs a forward discrete cosine transform (DCT) and inverse DCT. The quantizer syntax 830 performs precision reduction of the DCT coefficients for encoding and de-quantization for decoding. The encoder controller syntax 840 provides synchronization and control. The motion estimator syntax 860 performs forward and backward motion estimation and generates motion vectors. The encoder syntax 850 codes the motion vectors and the DCT data.

The reconstruction module syntax 870 is used by both video encoder and decoder. The reconstruction module syntax 870 receives information from the quantizer syntax 830 and the encoder controller syntax 840 such as block position, temporal reference, backward reference, forward reference, current picture, and quantized coefficients. The reconstruction module syntax 870 also receives the forward motion vector and backward motion vector as estimated by the motion estimator syntax 860. The reconstruction module syntax 870 generates the backward (B) data, the forward (F) data, and the display data. The reconstruction performs prediction using the inverse DCT on the de-quantized data, and the estimated motion vectors.

The decoder controller 880 provides timing and synchronization. The decoder syntax 890 decodes motion displacements and DCT data. The data port 735 receives video data from a video source (e.g., video camera) and transmits display data to a display device. The shared memory 770 stores video data that are used by many syntax. The shared memory 770 also stores data processed by one video syntax which is ready to be used by another video syntax. The memory controller and data organizer 850 controls the shared memory 770 and other external or cache memories in the system to ensure that data are transferred efficiently. For example, the memory controller and data organizer 850 can partition the memories dynamically so that several portions of the memory can be available for processing by many syntax at the same time.

The present invention provides a flexible and versatile technique to design applications specific integrated circuits for multimedia and communication applications. The technique provides a single-chip solution for complex multimedia tasks.

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. A method for performing a multimedia function, the method comprising:
receiving input data from a data port;
storing the input data in a shared memory; and
processing the input data by a multimedia syntax based on a configuration information, the multimedia syntax corresponding to the multimedia function.

2. The method of claim 1 wherein the configuration information is transmitted on a bus.

3. The method of claim 2 wherein processing the input data comprises:
accessing the configuration information by an interface access circuit;
timing an operation of the multimedia syntax by a clock enable circuit based on the configuration information; and
performing the operation on the input data by a multimedia syntax circuit.

4. The method of claim 3 wherein accessing the configuration information comprises:
accessing the bus by a bus access circuit;
decoding an input address corresponding to the multimedia syntax;
receiving the configuration information from the bus;
transmitting an output address to the bus; and
transmitting the configuration information to the bus corresponding to the output address.

5. The method of claim 4 wherein timing an operation comprises: generating epoch from the configuration information by a command status register;
selecting the generated epoch by a multiplexer;
timing an activity based on the selected epoch; and
generating a control timing signal and receiving a status timing signal by a command logic circuit.

6. The method of claim 5 wherein performing the operation comprises:
generating the status timing signal and receiving the control timing signals based on the command information by a command decode circuit;
receiving the command and data information by a command data processing circuit;
providing operating signals based on the data information and the control timing signal, the operating signals corresponding to the operation.

7. The method of claim 6 wherein the multimedia function is one of a video function, an audio function, and a data function.

8. The method of claim 7 wherein the video function includes an image coding, an image decoding, a motion estimation, a motion compensation, a discrete cosine transform, an inverse discrete cosine transform, a quantization, and an inverse quantization.

9. The method of claim 7 wherein the audio function includes an error correction, a CRC checking, a Reed-Solomon coding, a digital filtering, and an audio quantization.

10. The method of claim 7 wherein the data function includes a facsimiling, a text formatting, and a data processing.

11. An apparatus for performing a multimedia function, the apparatus comprising:
a data port for receiving input data;
a shared memory coupled to the data port for storing the input data; and
a multimedia syntax coupled to the shared memory for processing the input data based on a configuration information, the multimedia syntax corresponding to the multimedia function.

12. The apparatus of claim 11 wherein the configuration information is transmitted on a bus.

13. The apparatus of claim 12 wherein the multimedia syntax comprises:
an interface access circuit coupled to the bus for accessing the configuration information;
a clock enable circuit coupled to the bus and the interface access circuit for timing an operation of the multimedia syntax; and
a multimedia syntax circuit coupled to the interface access circuit and the clock enable circuit for performing the operation on the input data.

14. The apparatus of claim 13 wherein the interface access circuit comprises:
a bus access circuit coupled to the bus for accessing the bus;
an address decoder coupled to the bus for decoding an input address corresponding to the multimedia syntax;
a input command and data circuit coupled to the address decoder and the bus for receiving the configuration information from the bus;
an output address circuit coupled to the bus for transmitting an output address to the bus; and
an output command and data circuit coupled to the bus access circuit and the bus for transmitting the configuration information to the bus corresponding to the output address.

15. The apparatus of claim 14 wherein the clock enable circuit comprises:
a command status register for generating epoch from the configuration information;
a multiplexer coupled to the command status register for selecting the generated epoch;
an activity timer coupled to the multiplexer for timing an activity based on the selected epoch; and
command logic circuit coupled to the activity timer and the command status register for generating a control timing signal and receiving a status timing signal.

16. The apparatus of claim 15 wherein the media syntax circuit comprises:
a command decode circuit coupled to the clock enable circuit for generating the status timing signal and receiving the control timing signals based on the command information;
a command data processing circuit for receiving the command and data information, the command data processing circuit providing operating signals based on the data information and the control timing signal, the operating signals corresponding to the operation.

17. The apparatus of claim 16 wherein the multimedia function is one of a video function, an audio function, and a data function.

18. The apparatus of claim 17 wherein the video function includes an image coding, an image decoding, a motion estimation, a motion compensation, a discrete cosine transform, an inverse discrete cosine transform, a quantization, and an inverse quantization.

19. The apparatus of claim 17 wherein the audio function includes an error correction, a CRC checking, a Reed-Solomon coding, a digital filtering, and an audio quantization.

20. The apparatus of claim 17 wherein the data function includes a facsimiling, a text formatting, and a data processing.

21. A system comprising:
a radio communication unit for interfacing to a communication signal;
a communication interface module coupled to the radio communication unit for providing a media source; and
a media processor coupled to the communication interface module for performing a multimedia function corresponding to the media source, the media processor comprising:
a data port for receiving input data;
a shared memory coupled to the data port for storing the input data; and
a multimedia syntax coupled to the shared memory for processing the input data based on a configuration information,
the multimedia syntax corresponding to the multimedia function.

22. The system of claim 21 wherein the configuration information is transmitted on a bus.

23. The system of claim 22 wherein the multimedia syntax comprises:
an interface access circuit coupled to the bus for accessing the configuration information;
a clock enable circuit coupled to the bus and the interface access circuit for timing an operation of the multimedia syntax; and
a multimedia syntax circuit coupled to the interface access circuit and the clock enable circuit for performing the operation on the input data.

24. The system of claim 23 wherein the interface access circuit comprises:
a bus access circuit coupled to the bus for accessing the bus;
an address decoder coupled to the bus for decoding an input address corresponding to the multimedia syntax;
a input command and data circuit coupled to the address decoder and the bus for receiving the configuration information from the bus;
an output address circuit coupled to the bus for transmitting an output address to the bus; and
an output command and data circuit coupled to the bus access circuit and the bus for transmitting the configuration information to the bus corresponding to the output address.

25. The system of claim 24 wherein the clock enable circuit comprises:
a command status register for generating epoch from the configuration information;
a multiplexer coupled to the command status register for selecting the generated epoch;
an activity timer coupled to the multiplexer for timing an activity based on the selected epoch; and
command logic circuit coupled to the activity timer and the command status register for generating a control timing signal and receiving a status timing signal.

26. The system of claim 25 wherein the media syntax circuit comprises:
a command decode circuit coupled to the clock enable circuit for generating the status timing signal and receiving the control timing signals based on the command information;
a command data processing circuit for receiving the command and data information, the command data processing circuit providing operating signals based on the data information and the control timing signal, the operating signals corresponding to the operation.

27. The system of claim 26 wherein the multimedia function is one of a video function, an audio function, and a data function.

28. The system of claim 27 wherein the video function includes an image coding, an image decoding, a motion estimation, a motion compensation, a discrete cosine transform, an inverse discrete cosine transform, a quantization, and an inverse quantization.

29. The system of claim 27 wherein the audio function includes an error correction, a CRC checking, a Reed-Solomon coding, a digital filtering, and an audio quantization.

30. The system of claim 27 wherein the data function includes a facsimiling, a text formatting, and a data processing.
